(19) United States
(12) Patent Application Publication
(10) Pub. No.: US 2006/0070538 A1
(43) Pub. Date: Apr. 6, 2006

(54) Printing machine, and plate recording apparatus

(75) Inventors: Shinji Ito, Kyoto (JP); Hiroyuki Fuchioka, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/222,735

(22) Filed: Sep. 12, 2005

(30) Foreign Application Priority Data
Oct. 6, 2004 (JP) 2004-293632

(51) Int. Cl. B41F 5/00

(52) U.S. Cl. 101/216

(57) ABSTRACT

An image recording apparatus includes a recording head, a recording head move mechanism, and a light quantity correcting device. The recording head has a light source, an optical lens, a light emitting portion and a contact portion. The light quantity correcting device has a light quantity sensor with a light receiving portion, a cover glass plate, a base, a cylindrical cover, and a spring for biasing the cover toward the recording head.

### BACKGROUND OF THE INVENTION

1. Field of the Invention

This invention relates to a printing machine for recording an image on a printing plate, and printing the image by using the printing plate with the image recorded thereon. The invention relates also to a plate recording apparatus for recording an image on a printing plate.

2. Description of the Related Art

In an ordinary conventional printing machine, a prepress process is carried out first to make a printing plate by exposing the plate placed in contact with a film having a binary black and white image recorded thereon. Then, the plate is loaded into a printing apparatus to carry out a printing process.

Recently, printing machines commonly called digital printers have been proposed, one such printer being capable of performing both the prepress process and printing process. A digital printer, as described in U.S. Pat. No. 6,062,136A, for example, employs a “computer-to-plate” system for forming an image on a printing plate by directly scanning and exposing the plate with laser beams or the like modulated with image signals.

A printing machine as described in U.S. Pat. No. 6,062,136A has, arranged in the same space, plate cylinders for holding printing plates mounted peripherally thereof, blanket cylinders with blankets mounted peripherally thereof, an impression cylinder, image recorders for recording images on the printing plates mounted peripherally of the plate cylinders, and ink feeders for feeding inks to the printing plates mounted peripherally of the plate cylinders. A recording head is disposed close to each plate cylinder for recording images on the printing plate mounted peripherally of the plate cylinder.

In the printing machine capable of performing both the prepress process and printing process described above, the recording head is disposed around each plate cylinder even at a printing time. Mists and particles of the inks, water, paper powder and so on floating in the printing machine tend to adhere to the recording head. The quantity of light for recording could thereby be reduced to record defective images. Thus, the printing machine as described in U.S. Pat. No. 6,062,136A requires the recording head to be cleaned periodically.

To avoid the above inconvenience, a printing machine has been proposed, as described in U.S. Pat. No. 6,901,860B2, in which, in time of printing, a recording head is moved to a retreat position little prone to mists and particles of ink, water, paper powder and so on floating in the printing machine. Such a printing machine can minimize adhesion to the recording head of the mists and particles of ink, water, paper powder and so on floating in the printing machine. Thus, this printing machine requires the recording head to be cleaned less frequently.

However, where the printing machine as described in U.S. Pat. No. 6,901,860B2 includes a light quantity correcting device for receiving the light emitted from the recording head and correcting the quantity of light, a shielding plate or the like for the light quantity correcting device is additionally required to prevent the mists and particles of ink, water, paper powder and so on floating in the printing machine from adhering to the light quantity correcting device.

### SUMMARY OF THE INVENTION

The object of this invention, therefore, is to provide a printing machine simple in construction, and yet capable of preventing mists and particles of ink, water, paper powder and so on floating in the printing machine from adhering to a light emitting portion of a recording head and a light receiving portion of a light quantity correcting device.

The above object is fulfilled, according to this invention, by a printing machine for recording an image on a printing plate, and printing the image by using the printing plate with the image recorded thereon, comprising a plate cylinder rotatable with the printing plate mounted peripherally thereof; a recording head having a light emitting portion, and movable along a surface of the plate cylinder in a direction parallel to an axis of rotation of the plate cylinder for recording an image on the printing plate by emitting light from the light emitting portion; an ink feeder for feeding ink to the printing plate mounted peripherally of the plate cylinder and having the image recorded by the recording head; a moving device, operable at a printing time, for moving the recording head to a retreat position sideways from a moving region where the recording head is moved at an image-recording time; a light quantity correcting device having a light receiving portion disposed in a position opposed to the light emitting portion when the recording head has moved to the retreat position, the light quantity correcting device measuring a quantity of light received from the light emitting portion, and correcting a quantity of light emitted from the recording head; and a shielding device for shielding the light emitting portion and the light receiving portion from ambient when the recording head has moved to the retreat position.

With this printing machine, the shielding device shields the light emitting portion and light receiving portion from the ambient when the recording head has moved to the retreat position. Thus, although simple in construction, mists and particles of ink, water, paper powder and so on floating in the printing machine are prevented from adhering to the light emitting portion of the recording head and the light receiving portion of the light quantity correcting device.

In a preferred embodiment, the recording head includes a contact portion for contacting the shielding device when in the retreat position, and the shielding device includes a cylindrical member surrounding the light receiving portion, and a biasing device for biasing the cylindrical member toward the recording head so that, in a natural state, a forward end thereof projects beyond a forward end of the contact portion of the recording head.

The contact portion of the recording head may have a forward end of tapered sectional shape with respect to the direction of movement from the moving region to the retreat position.

In a different aspect of the invention, a printing machine comprises a plate cylinder rotatable with a printing plate mounted peripherally thereof; a recording head having a light emitting portion, and movable along a surface of the plate cylinder in a direction parallel to an axis of rotation of the plate cylinder for recording an image on the printing plate by emitting light from the light emitting portion; a shielding cover movable relative to the recording head for shielding the light emitting portion, the shielding cover having a light receiving portion disposed in a position opposed to the light emitting portion at a shielding time; and a light quantity correcting device for correcting a quantity of light emitted from the recording head, based on a quantity of light received by the light receiving portion.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view of a printing machine according to this invention;

FIG. 2 is a perspective view of a principal portion of an image recorder in the printing machine;

FIG. 3 is a schematic side view of the principal portion of the image recorder;

FIG. 4 is a schematic perspective view showing a recording head and adjacent components in a retreat position;

FIG. 5 is a schematic side view showing the recording head having moved to the retreat position and a light quantity correcting device;

FIG. 6 is a side view showing the light quantity correcting device in contact with the recording head;

FIG. 7 is an explanatory view showing a state of the light quantity correcting device when the recording head moves from a moving region to the retreat position;

FIG. 8 is an explanatory view showing a state of the light quantity correcting device when the recording head moves from the moving region to the retreat position;

FIG. 9 an explanatory view showing a state of the light quantity correcting device when the recording head moves from the moving region to the retreat position; and

FIG. 10 is a flow chart showing a process of correcting the quantity of light of the recording head by the light quantity correcting device.

FIG. 11 is a schematic side view of a modified embodiment.

### DESCRIPTION OF THE PREFERRED EMBODIMENTS

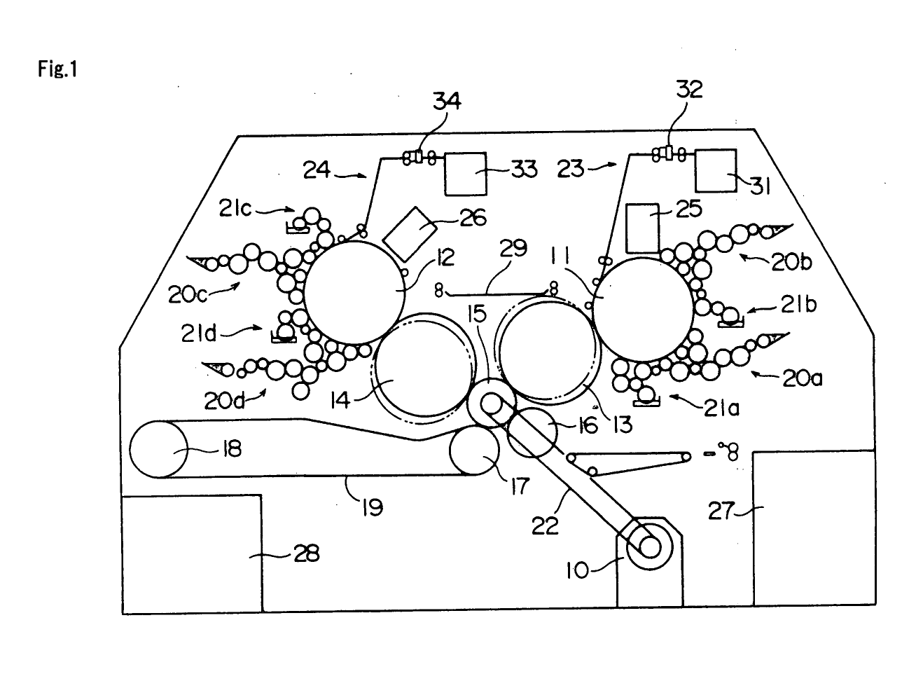

An embodiment of this invention will be described hereinafter with reference to the drawings. FIG. 1 is a schematic view of a printing machine according to the invention.

This printing machine makes printing plates by recording and developing images on blank plates mounted on first and second plate cylinders 11 and 12, feeds inks to the plates having the images recorded thereon, and transfers the inks from the plates through first and second blanket cylinders 13 and 14 to printing paper mounted on an impression cylinder 15, thereby printing the images on the printing paper.

The first blanket cylinder 13 is contactable with the first plate cylinder 11, while the second blanket cylinder 14 is contactable with the second plate cylinder 12. The impression cylinder 15 is contactable with the first and second blanket cylinders 13 and 14 in different positions. The machine further includes a paper feed cylinder 16 for transferring printing paper supplied from a paper magazine 27 to the impression cylinder 15, a paper discharge cylinder 17 with chains 19 wound thereon and on a sprocket 18 for discharging printed paper from the impression cylinder 15 to a paper discharge station 28.

The impression cylinder 15 contactable by the first and second blanket cylinders 13 and 14 has half the diameter of the first and second plate cylinders 11 and 12 and the first and second blanket cylinders 13 and 14. Further, the impression cylinder 15 has a gripper, not shown, for holding and transporting the forward end of printing paper.

The paper feed cylinder 16 disposed adjacent the impression cylinder 15 has the same diameter as the impression cylinder 15. The paper feed cylinder 16 has a gripper, not shown, for holding and transporting the forward end of each sheet of printing paper fed from the paper magazine 27. When the printing paper is transferred from the feed cylinder 16 to the impression cylinder 15, the gripper of the impression cylinder 15 holds the forward end of the printing paper which has been held by the gripper of the feed cylinder 16.

The paper discharge cylinder 17 disposed adjacent the impression cylinder 15 has the same diameter as the impression cylinder 15. The discharge cylinder 17 has a pair of chains 19 wound around opposite ends thereof. The chains 19 are interconnected by coupling members, not shown, having grippers arranged thereon. When the impression cylinder 15 transfers the printing paper to the discharge cylinder 17, one of the grippers of the discharge cylinder 17 holds the forward end of the printing paper having been held by the gripper of the impression cylinder 15. With movement of the chains 19, the printing paper is discharged to the paper discharge station 28.

The impression cylinder 15 is connected to a drive motor 10 through a belt 22. The impression cylinder 15, feed cylinder 16, discharge cylinder 17 and first and second blanket cylinders 13 and 14 are connected to one another through gears attached to ends thereof, respectively. Further, the first blanket cylinder 13 is connected to the first plate cylinder 11, and the second blanket cylinder 14 to the second plate cylinder 12 by gears attached to ends thereof, respectively, when the first and second blanket cylinders 13 and 14 are in printing positions described hereinafter. Thus, the drive motor 10 rotates the feed cylinder 16, impression cylinder 15, discharge cylinder 17, first and second blanket cylinders 13 and 14, and first and second plate cylinders 11 and 12 synchronously with one another.

The first plate cylinder 11 has, arranged therearound, an ink feeder 20a for feeding black ink (K), for example, to a plate, an ink feeder 20b for feeding magenta ink (M) to a different plate, and dampening water feeders 21a and 21b for feeding dampening water to the plates. The second plate cylinder 12 has, arranged therearound, an ink feeder 20c for feeding cyan ink (C) to a plate, an ink feeder 20d for feeding yellow ink (Y) to a different plate, and dampening water feeders 21c and 21d for feeding dampening water to the plates.

Further, the first and second plate cylinders 11 and 12 have, arranged therearound, a plate feeder 23 for feeding plates to the periphery of the first plate cylinder 11, a plate feeder 24 for feeding plates to the periphery of the second plate cylinder 12, an image recorder 25 for recording images on the plates mounted peripherally of the first plate cylinder 11, an image recorder 26 for recording images on the plates mounted peripherally of the second plate cylinder 12, and a plate discharger 29 common to the first and second plate cylinders 11 and 12.

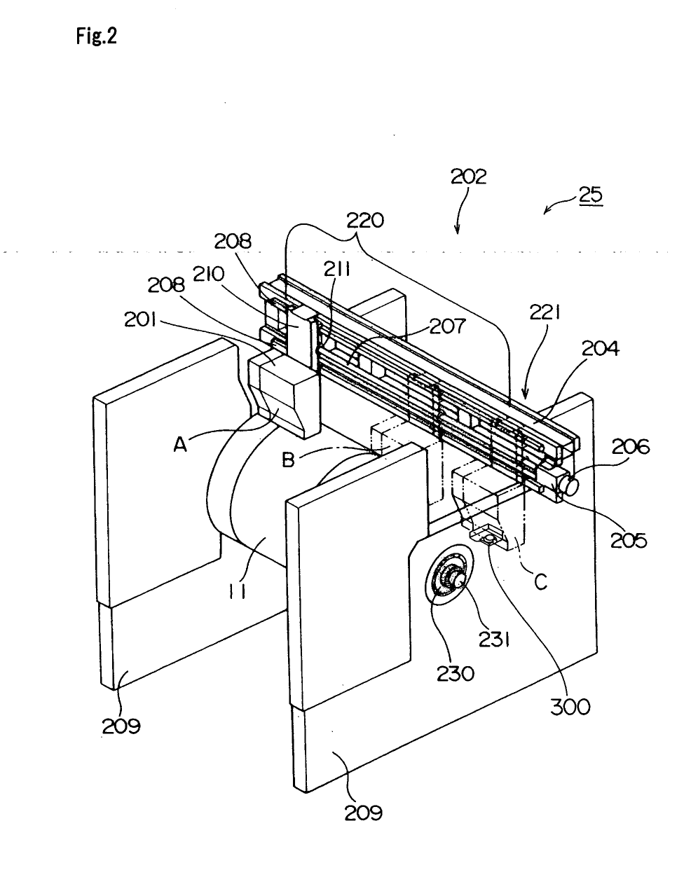

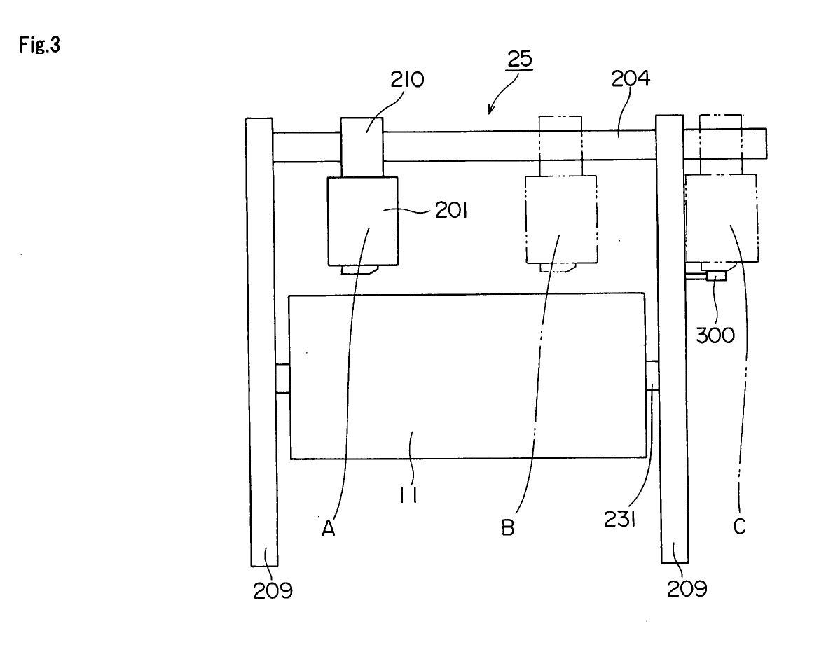

Each of the image recorders 25 and 26 includes a recording head moving mechanism 202 for moving a recording head 201 to a retreat position in time of printing (FIGS. 2 and 3). The recording head moving mechanism 202 will be described in detail hereinafter.

In the printing machine having the above construction, a printing plate drawn from a supply cassette 31 in the plate feeder 23 is cut to a predetermined size by a cutter 32. A forward end of the printing plate cut into sheet form is guided by guide rollers and a guide member, and clamped by a clamping jaw on the first plate cylinder 11. Then, the first plate cylinder 11 is rotated by a motor 43 described hereinafter, whereby the printing plate is wound peripherally of the first plate cylinder 11. The rear end of the printing plate is clamped by a different clamping jaw.

While, in this state, the first plate cylinder 11 is rotated at low speed by the motor 43, the image recorder 25 irradiates the surface of the plate mounted peripherally of the first plate cylinder 11 with a modulated laser beam for recording an image thereon.

Similarly, a printing plate drawn from a supply cassette 33 in the plate feeder 24 is cut to a predetermined size by a cutter 34. A forward end of the printing plate cut into sheet form is guided by guide rollers and a guide member, and clamped by a clamping jaw on the second plate cylinder 12. Then, the second plate cylinder 12 is rotated by a motor 43 described hereinafter, whereby the printing plate is wound peripherally of the second plate cylinder 12. The rear end of the printing plate is clamped by a different clamping jaw.

While, in this state, the second plate cylinder 12 is rotated at low speed by the motor 43, the image recorder 26 irradiates the surface of the plate mounted peripherally of the second plate cylinder 12 with a modulated laser beam for recording an image thereon.

The first plate cylinder 11 holds two printing plates mounted peripherally thereof, one for printing in the black ink and the other in the magenta ink. These two printing plates are arranged in evenly separated positions, i.e. in positions separated from each other by 180 degrees. The image recorder 25 records images on these printing plates. Similarly, the second plate cylinder 12 holds two printing plates mounted peripherally thereof, one for printing in the cyan ink and the other in the yellow ink. These two printing plates also are arranged in evenly separated positions. The image recorder 26 records images on these printing plates to complete a platemaking process.

The platemaking process is followed by a printing process for printing the printing paper with the plates mounted on the first and second plate cylinders 11 and 12. The printing process is carried out as follows.

First, each dampening water feeder 21 and each ink feeder 20 are placed in contact with only a corresponding one of the plates mounted on the first and second plate cylinders 11 and 12. Consequently, dampening water and inks are fed to the plates from the corresponding water feeders 21 and ink feeders 20, respectively. The inks fed to the plates are transferred to the first and second blanket cylinders 13 and 14, respectively.

Then, the printing paper is fed to the paper feed cylinder 16. The printing paper is subsequently passed from the paper feed cylinder 16 to the impression cylinder 15. The impression cylinder 15 continues to rotate in this state. Since the impression cylinder 15 has half the diameter of the first and second plate cylinders 11 and 12 and the first and second blanket cylinders 13 and 14, the black and cyan inks are transferred to the printing paper wrapped around the impression cylinder 15 in its first rotation, and the magenta and yellow inks in its second rotation.

The forward end of the printing paper printed in the four colors is passed from the impression cylinder 15 to the paper discharge cylinder 17. This printing paper is transported by the pair of chains 19 to the paper discharge station 28 to be discharged therein.

Upon completion of the printing process, the plates used in the printing are discharged to the plate discharger 29. Then, the first and second blanket cylinders 13 and 14 are cleaned by a blanket cleaning unit, not shown, to complete the printing process.

In such a printing machine as described above, where the recording heads of the image recorders 25 and 26 are arranged close to the first and second plate cylinders 11 and 12 at a printing time, mists and particles of the inks, water, paper powder and so on floating in the printing machine tend to adhere to the recording heads. Where light quantity correcting devices 300 for the recording heads 201 as described in detail hereinafter are arranged in the printing machine, the mists and particles of the inks, water, paper powder and so on floating in the printing machine tend to adhere to the light quantity correcting devices 300. This printing machine, therefore, includes a shielding device for shielding off a light emitting portion of each recording head 201 and a light receiving portion of each light quantity correcting device 300 when the recording head 201 has moved to the retreat position.

The construction of the image recorders 25 and 26 will be described hereinafter. FIG. 2 is a perspective view showing a principal portion of the image recorder 25 in the printing machine according to this invention. FIG. 3 is a schematic side view corresponding to FIG. 2 of the image recorder 25.

The image recorder 26 has the same construction as the image recorder 25, and will not particularly be described.

The image recorder 25 includes a recording head 201, a recording head moving mechanism 202, and a light quantity correcting device 300 for correcting the quantity of light emitted from the recording head 201. The recording head moving mechanism 202 has a support member 204 extending between a pair of side plates 209 rotatably supporting the first plate cylinder 11 through bearings 230, a pair of guide rails 208 fixed to a side surface of the support member 204, and a ball screw 207 extending parallel to the guide rails 208. The pair of guide rails 208 and the ball screw 207 extend parallel to an axis 231 of the first plate cylinder 11. The ball screw 207 is connected through a speed reducer 205 to a motor 206 fixed to an end of the support member 204. The ball screw 207 is meshed with a nut 211 attached to a support plate 210 supporting the recording head 201. Thus, the motor 206 is operable to rotate the ball screw 207, thereby to move the recording head 201 parallel to the axis 231 of the first plate cylinder 11.

In time of recording an image, this recording head moving mechanism 202 moves the recording head 201 through a moving region 220 between a recording start position A shown in solid lines in FIGS. 2 and 3 and a recording finish position B shown in phantom lines to record the image on the printing plate mounted peripherally of the first plate cylinder 11. After recording the image, the recording head 201 is moved to a retreat position 221 shown in phantom lines C in FIGS. 2 and 3, which is displaced sideways from the moving region 220. The recording head 201 is kept on standby in the retreat position 221 until a next image recording time.

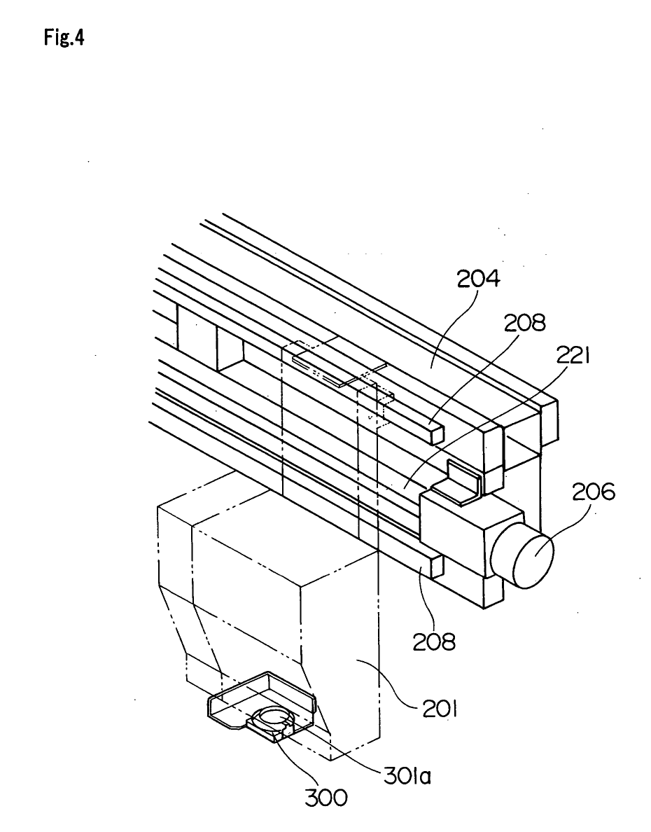

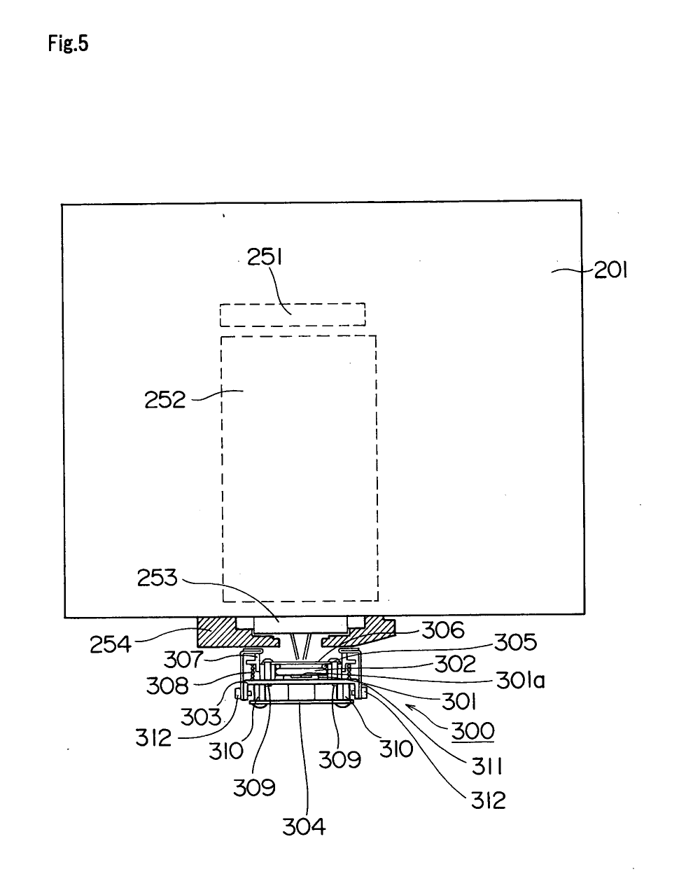

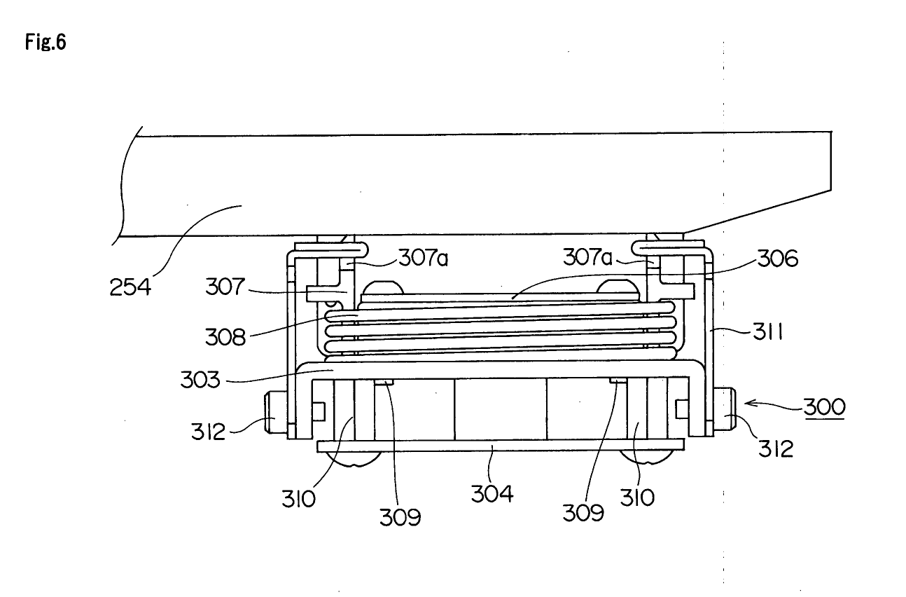

FIG. 4 is a schematic perspective view showing the recording head 201 and adjacent components in the retreat position 221. FIG. 5 is a schematic side view showing the recording head 201 having moved to the retreat position 221 and the light quantity correcting device 300. FIG. 6 is a side view showing the light quantity correcting device 300 in contact with the recording head 201.

The recording head 201 includes a light source 251 mounted inside, an optical system 252 for condensing the light from the light source 251, a light emitting portion 253 for emitting the light having passed through the optical system 252, and a contact portion 254 for contacting the light quantity correcting device 300. The light source 251 has numerous laser diodes arranged two-dimensionally. The contact portion 254 has a forward end of tapered sectional shape with respect to the direction of movement of the recording head 201 from the moving region 220 to the retreat position 221.

The light quantity correcting device 300 includes a light quantity sensor 301 having a light receiving portion 301a for receiving the light emitted from the light emitting portion 253 of the recording head 201, a cover glass plate 302 for adjusting the light to the light quantity sensor 301, a base 304 electrically connected to the light quantity sensor 301, a support 303 for supporting the light quantity sensor 301 and base 304, a cylindrical cover 307 surrounding the light quantity sensor 301 and cover glass plate 302, a spring 308 for biasing the cover 307 toward the recording head 201, and a presser 311 for limiting the projection of the cover 307 toward the recording head 201 under the biasing force of the spring 308. A protective glass plate 306 is attached through an O-ring 305 to surfaces opposed to the recording head 201 of the light quantity sensor 301 and cover glass plate 302. The protective glass plate 306 and support 303 are fixed to each other by screws 309. The base 304 and support 303 are fixed to each other by screws 310. The presser 311 and support 303 are fixed to each other by screws 312. The spring 308 may be replaced with a different biasing device such as a plate spring, or the cover 307 itself may, for example, be formed of a flexible material to be capable of expansion and contraction.

The light quantity correcting device 300 is disposed to have the light quantity sensor 301 and cover glass plate 302 opposed to the light emitting portion 253 of the recording head 201 in the retreat position 221. The light quantity sensor 301 has a light receiving area for receiving light from all the laser diodes of the light source 251. Thus, one light quantity sensor 301 can perform measurement for all the laser diodes successively. The cover 307 is biased by the spring 308 such that, in a natural state, the forward end thereof opposed to the recording head 201 projects beyond the forward end opposed to the light quantity correcting device 300 of the contact portion 254 of the recording head 201. Consequently, as described hereinafter, when the recording head 201 is in the retreat position 221, the light emitting portion 253, light quantity sensor 301 and cover glass plate 302 are effectively shielded from the ambient.

The cover 307 has a cutout 307a formed therein for allowing the presser 311 to move relative thereto. Strictly, therefore, the cutout 307a provides a slight space that allows air flows, between the light emitting portion 253 of the recording head 201 and the light quantity light sensor 301, and the ambient. However, by minimizing this space, the inks, water, paper powder and so on may be prevented effectively from adhering to the light emitting portion 253 and light quantity sensor 301. In this specification, the term shielding not only refers to the light emitting portion 253 and light quantity sensor 301 being shut off in airtight state from the ambient, but includes a case where the light emitting portion 253 and light quantity sensor 301 are shut off, leaving a slight gap, from the ambient. It is possible to eliminate the cutout 307a by arranging that the presser 311 acts on other positions than the upper end of the cover 307.

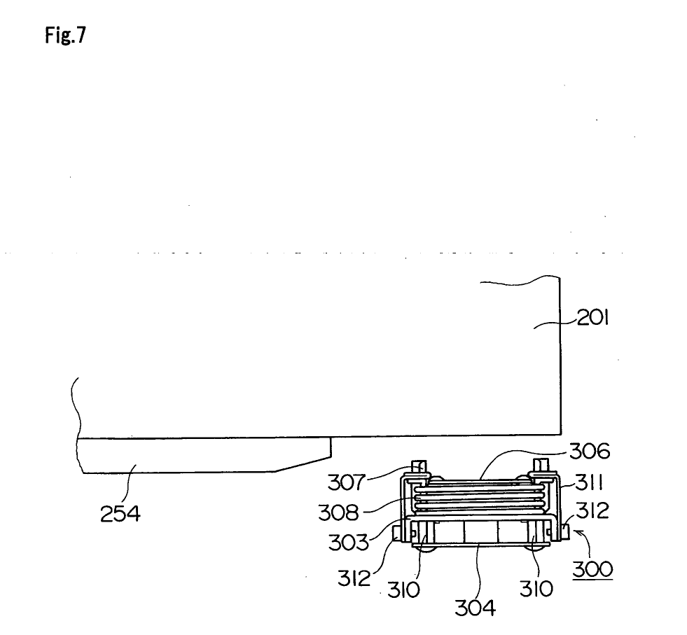

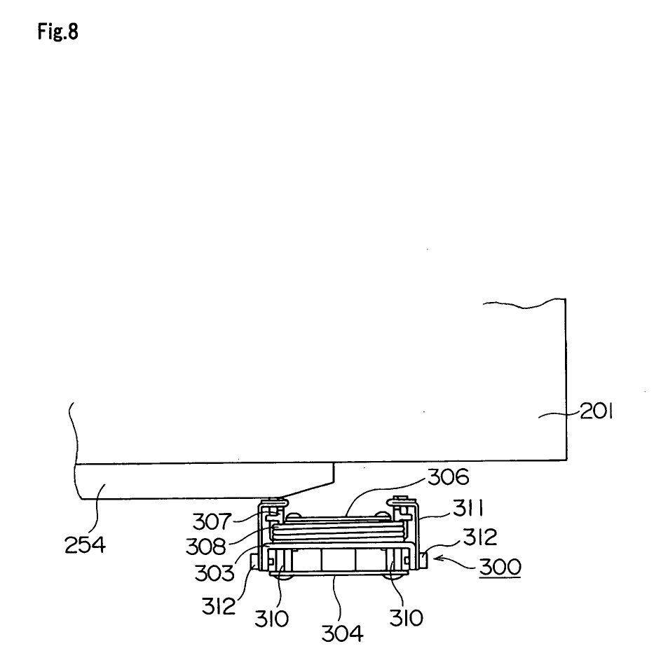

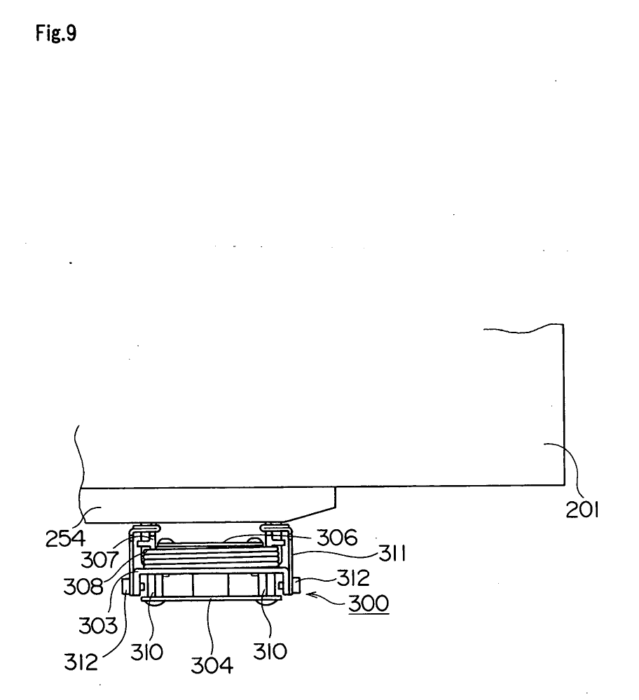

FIGS. 7 through 9 are explanatory views showing states of the light quantity correcting device 300 when the recording head 201 moves from the moving region 220 to the retreat position 221. FIG. 7 shows a state where the contact portion 254 and light quantity correcting device 300 are out of contact with each other. FIG. 8 shows a state where part of the contact portion 254 is in contact with the light quantity correcting device 300. FIG. 9 shows a state where the contact portion 254 is completely in contact with the light quantity correcting device 300.

When the recording head 201 moves from the moving region 220 to the retreat position 221, the cover 307 of the light quantity correcting device 300 is arranged to have the forward end thereof projecting to an extent of interfering with the forward end of the contact portion 254 as shown in FIG. 7. As the recording head 201 moves in this state to the position shown in FIG. 8, the forward end of the cover 307 and the forward end of the contact portion 254 come into pressure contact with each other. The forward end with respect to the direction of movement of the contact portion 254 is shaped to have a tapered section as noted hereinbefore, which enables a smooth contact between the light quantity correcting device 300 and recording head 201.

When the recording head 201 has moved to the retreat position 221 as shown in FIG. 9, the contact portion 254 of the recording head 201 presses the cover 307 biased toward the recording head 201 by the spring 308. Consequently, the light emitting portion 253 of the recording head 201 and the light receiving portion 301a of the light quantity correcting device 300 are effectively shielded off from the ambient. The printing machine in this embodiment, although simple in construction, can prevent mists and particles of the inks, water, paper powder and so on floating in the printing machine from adhering to the light emitting portion 253 of the recording head 201 and the light receiving portion 301a of the light quantity correcting device 300.

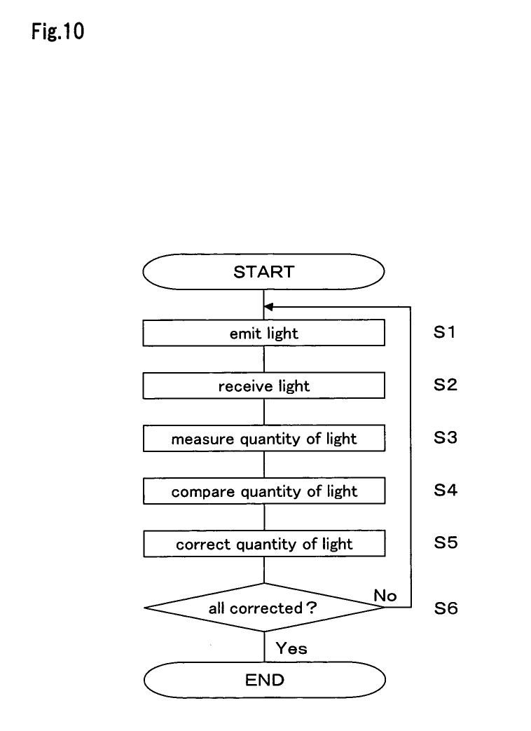

Next, a process of correcting the quantity of light using the light quantity correcting device 300 will be described. FIG. 10 is a flow chart showing the process of correcting the quantity of light of the recording head 201 by the light quantity correcting device 300.

The correction of the quantity of light of the recording head 201 is carried out for each laser diode. When correcting the quantity of light of the recording head 201, a voltage is first applied to only one of the laser diodes to emit light therefrom (step S1).

The light emitted from the one laser diode in step S1 is received by the light receiving portion 301a of the light quantity sensor 301 (step S2).

The light received by the light receiving portion 301a is converted into an electric signal. The electric signal is transmitted through the base 304 to a controller not shown. The electric signal transmitted is measured by the controller (step S3).

The controller compares a voltage or current value of the electric signal measured in step S3 with a reference voltage or current value stored in the controller beforehand (step S4).

When a result of the comparison made in step S4 shows a difference exceeding a predetermined value between the measured voltage or current value and the reference voltage or current value, the voltage applied to the laser diode is corrected. This corrects the quantity of light emitted from the laser diode (step S5).

The quantity of light is corrected for the other laser diodes in the same way. When the quantity of light has been corrected for all the laser diodes, the process of correcting the quantity of light of the recording head 201 is completed (step S6).

In the above embodiment, the light source 251 has numerous laser diodes arranged two-dimensionally. Instead, the light source 251 may have a single laser diode, or may have other components than the laser diodes as long as the quantity of light thereof can be controlled.

In the above embodiment, the recording head 201 is movable to the retreat position 221 outside one of the side plates 209, and is opposed to the light quantity correcting device 300 in the retreat position 221. It is desirable from the viewpoint of protection against dust that the recording head 201 is retracted to the retreat position 221 outside of the side plate 209. However, as long as the recording head 201 and light quantity correcting device 300 closely contact each other to shield themselves from the ambient, the recording head 201 and light quantity correcting device 300 may contact each other in a position other than the retreat position 221.

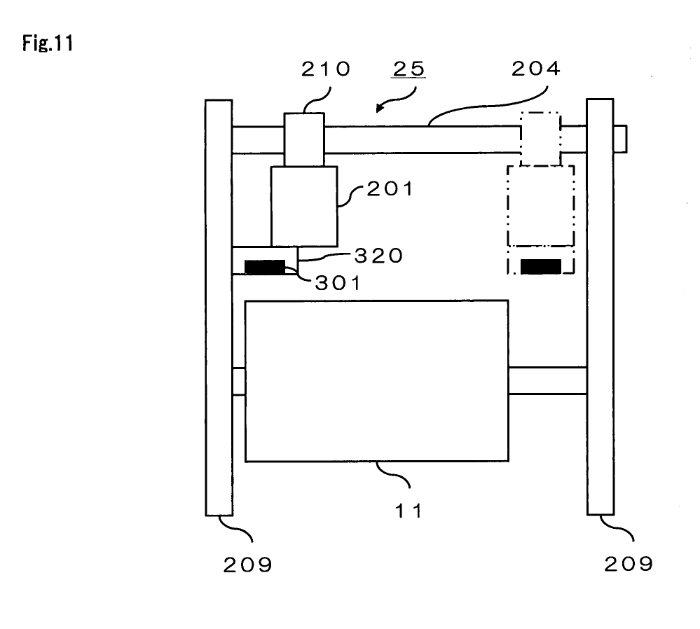

As shown in FIG. 11, for example, a shielding cover 320 may be provided to be movable relative to the light emitting portion of the recording head 201 for shielding or opening the light emitting portion. The shielding cover 320 may have a light quantity sensor 301 as the light quantity correcting device 300, mounted inside and in a position opposed to the light emitting portion in time of shielding the latter.

The foregoing embodiment has been described centering on the light emitting portion and light quantity correcting device in the printing machine with a platemaking function. The light emitting portion and light quantity correcting device according to this invention are applicable also to a CPT (plate recording apparatus) having no printing function.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2004-293632 filed in the Japanese Patent Office on Oct. 6, 2004, the entire disclosure of which is incorporated herein by reference.

What is claimed is:

1. A printing machine for recording an image on a printing plate, and printing the image by using the printing plate with the image recorded thereon, comprising:
a plate cylinder rotatable with the printing plate mounted peripherally thereof;
a recording head having a light emitting portion, and movable along a surface of said plate cylinder in a direction parallel to an axis of rotation of said plate cylinder for recording an image on said printing plate by emitting light from said light emitting portion;
an ink feeder for feeding ink to said printing plate mounted peripherally of said plate cylinder and having the image recorded by said recording head;
a moving device, operable at a printing time, for moving said recording head to a retreat position sideways from a moving region where said recording head is moved at an image-recording time;
a light quantity correcting device having a light receiving portion disposed in a position opposed to said light emitting portion when said recording head has moved to said retreat position, said light quantity correcting device measuring a quantity of light received from said light emitting portion, and correcting a quantity of light emitted from said recording head; and
a shielding device for shielding said light emitting portion and said light receiving portion from ambient when said recording head has moved to said retreat position.

2. A printing machine as defined in claim 1, further comprising a shielding plate disposed between said moving region and said retreat position, and defining an opening for allowing passage of said recording head.

3. A printing machine as defined in claim 2, wherein said shielding plate is a side plate for supporting said plate cylinder.

4. A printing machine as defined in claim 1, wherein:
said recording head includes a contact portion for contacting said shielding device when in said retreat position; and
said shielding device includes a cylindrical member surrounding said light receiving portion, and a biasing device for biasing said cylindrical member toward said recording head so that, in a natural state, a forward end thereof projects beyond a forward end of said contact portion of said recording head.

5. A printing machine as defined in claim 4, further comprising a shielding plate disposed between said moving region and said retreat position, and defining an opening for allowing passage of said recording head.

6. A printing machine as defined in claim 5, wherein said shielding plate is a side plate for supporting said plate cylinder.

7. A printing machine as defined in claim 4, wherein said contact portion of said recording head has a forward end of tapered sectional shape with respect to the direction of movement from said moving region to said retreat position.

8. A printing machine as defined in claim 7, further comprising a shielding plate disposed between said moving region and said retreat position, and defining an opening for allowing passage of said recording head.

9. A printing machine as defined in claim 8, wherein said shielding plate is a side plate for supporting said plate cylinder.

10. A printing machine as defined in claim 1, wherein:
said light emitting portion has a plurality of laser diodes; and
said light receiving portion has a light receiving area for receiving light emitted from all said laser diodes.

11. A printing machine for recording an image on a printing plate, and printing the image by using the printing plate with the image recorded thereon, comprising:
a plate cylinder rotatable with the printing plate mounted peripherally thereof;
a recording head having a light emitting portion, and movable along a surface of said plate cylinder in a direction parallel to an axis of rotation of said plate cylinder for recording an image on said printing plate by emitting light from said light emitting portion;
a shielding cover movable relative to said recording head for shielding said light emitting portion, said shielding cover having a light receiving portion disposed in a position opposed to said light emitting portion at a shielding time; and
a light quantity correcting device for correcting a quantity of light emitted from said recording head, based on a quantity of light received by said light receiving portion.

12. A plate recording apparatus for recording an image on a printing plate, comprising:
a drum rotatable with the printing plate mounted peripherally thereof;
a recording head having a light emitting portion, and movable along a surface of said drum in a direction parallel to an axis of rotation of said drum for recording an image on said printing plate by emitting light from said light emitting portion;
a moving device, operable at a non-recording time, for moving said recording head to a retreat position sideways offset from said drum;
a light quantity correcting device having a light receiving portion disposed in a position opposed to said light emitting portion when said recording head has moved to said retreat position, said light quantity correcting device measuring a quantity of light received from said light emitting portion, and correcting a quantity of light emitted from said recording head; and
a shielding device for shielding from ambient said light emitting portion and said light receiving portion opposed to each other when said recording head has moved to said retreat position.
